(19) United States
(12) Patent Application Publication
(10) Pub. No.: US 2023/0398743 A1
(43) Pub. Date: Dec. 14, 2023

(54) Device That Reduces 3D Printing Unwanted Strands of Plastic

(71) Applicant: Clyde T. Eisenbeis, Bismarck, ND (US)

(72) Inventor: Clyde T. Eisenbeis, Bismarck, ND (US)

(21) Appl. No.: 17/839,608

(22) Filed: Jun. 14, 2022

(51) Int. Cl. B29C 64/314; B29C 64/209; B29C 64/321; B29C 64/118; B33Y 30/00; B33Y 40/10

(52) U.S. Cl. CPC B29C 64/314; B29C 64/209; B29C 64/321; B29C 64/118; B33Y 30/00; B33Y 40/10

(57) ABSTRACT

A feature on a 3D printer that reduces unwanted plastic strands between 3D object vertical structures by cooling the recently extruded plastic.

### DESCRIPTION OF INVENTION

### Field

This utility patent application relates to 3D printers.

### Background

A 3D printer is used to print 3D objects. For many 3D printers, the material used for printing 3D objects are a variety of plastics such as PLA, PETG, ASA, and ABS. These plastics are known as filaments.

A 3D printer prints one layer at a time by extruding filament through a 3D printer nozzle output hole. Even though the filament diameter is commonly larger than the 3D printer nozzle output hole diameter, the filament is melted by temperature and squeezed out of the 3D printer nozzle output hole.

The 3D printer prints the first layer of the 3D object, then increments upwards to print the second layer of the 3D object. This continues until the top layer of the 3D object is printed.

When vertical structures, that are part of a 3D object, are separated by distance between the vertical structures, there can be unwanted strands of plastic between those vertical structures.

When there is a gap between structures, the 3D printer nozzle stops extruding filament. Even though the 3D printer nozzle stops extruding filament, there is still filament in the 3D printer nozzle output hole. The filament in the 3D printer nozzle output hole can remain attached to the recently extruded plastic of the 3D object because of the higher temperature of the recently extruded plastic.

When the 3D printer nozzle moves to a new location some distance from the last filament extrusion, there can be unwanted strands of plastic between the structures.

### SUMMARY

It is good to cool the extruded plastic when the 3D Printer nozzle stops extruding filament. Extruded plastic, that is cooled, will seldom stick to the filament inside the 3D printer nozzle output hole. Cooling the recently extruded plastic reduces unwanted strands of plastic.

The extruded plastic could be cooled many ways. One way is to move air (or other gas, or liquid), near the 3D printer nozzle output hole and near the recently extruded plastic, when the 3D printer nozzle stops extruding plastic.

When the recently extruded plastic is cooled, it will be less likely to cling to the filament inside the 3D printer nozzle output hole. Cooling the recently extruded plastic reduces unwanted strands of plastic.

### BRIEF DESCRIPTION OF THE DRAWINGS

FIG. 1 displays a front view of a 3D printer 200 with a 3D printer nozzle 201 which includes a 3D printer nozzle output hole 202 that is printing a 3D object 203.

FIG. 2 displays unwanted strands of plastic 204 between the 3D object 203 vertical structures.

FIG. 3 displays the addition of an air nozzle 205 with an air nozzle secondary hole 206 and an air nozzle primary hole 207 which is near the 3D printer nozzle output hole 202 that is extruding filament.

FIG. 4 displays the desired end result of the 3D object 203 (with no unwanted strands of plastic) with the addition of an air nozzle 205.

FIG. 5 displays a cross section of the air nozzle 205 which displays a fan 208 inside the air nozzle 205 chamber.

FIG. 6 displays a cross section of the air nozzle 205 chamber which displays a spherical object 209 inside the air nozzle 205 chamber.

FIG. 7 displays a cross section of the air nozzle 205 chamber which displays a spherical object 209 near the air nozzle secondary hole 206.

FIG. 8 displays a cross section of the air nozzle 205 chamber which displays a spherical object 209 near the air nozzle primary hole 207.

FIG. 9 displays a cross section of the air nozzle 205 chamber which displays a solenoid 210 inside the air nozzle solenoid chamber 211 which is connected to the air nozzle primary hole chamber 212.

### DETAILED DESCRIPTION

The present disclosure is directed to a 3D printing device that prints 3D objects. In particular, the addition of an air nozzle reduces unwanted strands of plastic between 3D object vertical structures.

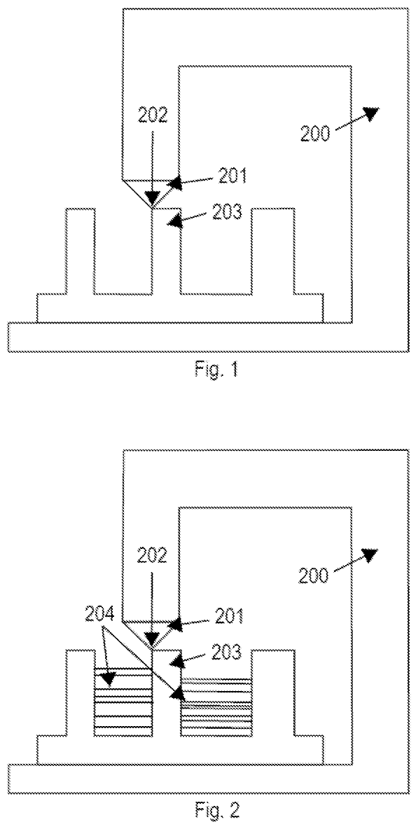

Referring to FIG. 1, a 3D printer 200 is nearing completion of printing a 3D object 203. The 3D printer prints one layer at a time by extruding filament via a 3D printer nozzle 201, specifically extruding filament via a 3D printer nozzle output hole 202. Even though the filament diameter is commonly larger than the 3D printer nozzle output hole 202 diameter, the filament is melted by temperature, then squeezed out of the 3D printer nozzle output hole 202. The 3D printer 200 prints the first layer of the 3D object 203, then increments upwards to print the second layer of the 3D object 203. This continues until the top layer of the 3D object 203 is printed. The 3D object 203 in FIG. 1 is the desired end result.

Referring to FIG. 2, the 3D object 203 has some unwanted strands of plastic 204 between 3D object 203 vertical structures. These unwanted strands of plastic 204 are not part of the desired end result. When there is a gap between structures on a 3D object 203, the 3D printer nozzle 201 stops extruding filament. Even though the 3D printer nozzle 201 stops extruding filament, there is still filament inside the 3D printer nozzle output hole 202. The filament, that is inside the 3D printer nozzle output hole 202, can remain attached to the recently extruded plastic of the 3D object 203 because of the higher temperature of the recently extruded plastic. When the 3D printer nozzle 201 moves to another location, some distance from the recently extruded plastic of the 3D object 203, there can be unwanted plastic strands between the 3D object 203 vertical structures.

Referring to FIG. 3, an air nozzle 205 has been added to the 3D printer 200. The air nozzle primary hole 207 is near the 3D printer nozzle output hole 202 that extrudes filament. The air nozzle primary hole 207 moves air near the 3D printer nozzle output hole 202. The movement of air through the air nozzle primary hole 207 is similar to the movement of air through the air nozzle secondary hole 206. The air nozzle primary hole 207 could be multiple holes. The air nozzle secondary hole 206 could be multiple holes.

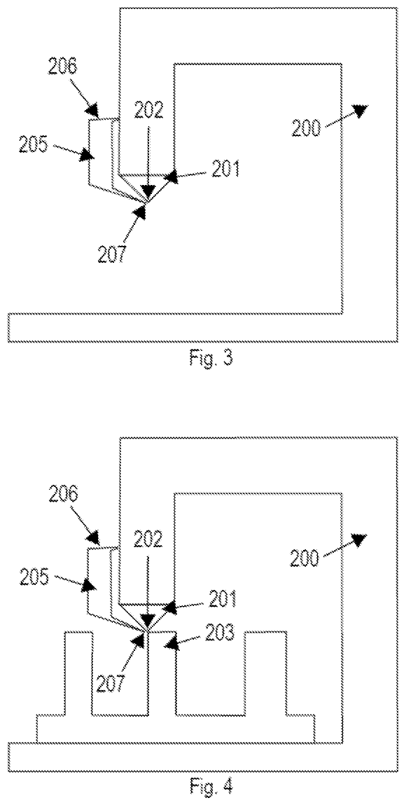

Referring to FIG. 4, a 3D object 203 desired end result can occur when, at the appropriate time, air is moved through an air nozzle primary hole 207 that is near the 3D printer nozzle output hole 202 and near the recently extruded plastic 203. When the recently extruded plastic 203 is cooled, it will be less likely to cling to the filament in the 3D printer nozzle output hole 202. This would reduce unwanted strands of plastic. The 3D object 203 has reduced unwanted strands of plastic, which is the desired end result.

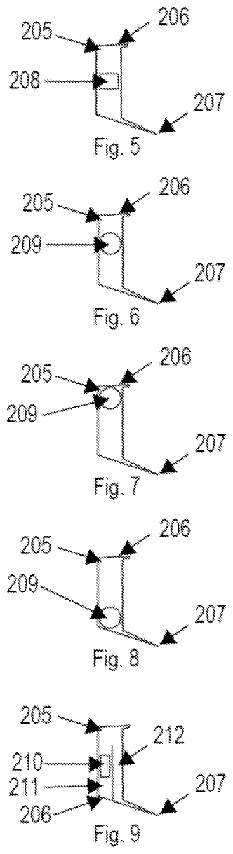

Referring to FIG. 5, a cross section of the air nozzle 205 displays a fan 208 that is inside the air nozzle 205 chamber. The fan 208 could be any device that moves air through air nozzle primary hole 207.

Referring to FIG. 6, a cross section of the air nozzle 205 displays a spherical object 209 that is inside the air nozzle 205 chamber. The spherical object 209 is similar to a ball bearing with a diameter similar to the air nozzle 205 chamber diameter. The object 209, could be non-spherical.

Referring to FIG. 7, a cross section of the air nozzle 205 displays the spherical object 209, that is inside the air nozzle 205 chamber, near the air nozzle secondary hole 206. This occurs when the air nozzle 205 is tipped upside down. The air nozzle 205 does not need to be perfectly upside down. The air nozzle 205 needs to be tipped enough for the object 209 to move in the direction of the air nozzle secondary hole 206.

Referring to FIG. 8, a cross section of the air nozzle 205 displays the spherical object 209, that is inside the air nozzle 205 chamber, near the air nozzle primary hole 207. This occurs when the air nozzle 205 is tipped back to the original position with the air output hole near the bottom. When this occurs, air is moved through the air nozzle primary hole 207.

Referring to FIG. 9, a cross section of the air nozzle 205 displays a solenoid 210 inside the air nozzle solenoid chamber 211. The air nozzle 205 is split into two chambers throughout the entire length, except for one area that is open between the air nozzle solenoid chamber 211 and the air nozzle primary hole chamber 212. When the solenoid 210 is activated, the solenoid plunger moves air through the air nozzle primary hole 207. When the solenoid 210 is deactivated, the solenoid plunger moves to its original position. The solenoid 210 plunger is large enough to move air through the air nozzle primary hole 207. The solenoid 210 and plunger could also move against another object which is large enough to move air through the air nozzle primary hole 207. The air nozzle solenoid chamber 211 and the air nozzle primary hole chamber 212 could be combined into one chamber.

1. A device that reduces unwanted plastic strands of plastic by cooling the plastic extruded by a 3D printer.

2. The device according to claim 1 that moves air through the device primary hole.

3. The device according to claim 1 that moves air through the device primary holes.

4. The device according to claim 1 that moves other types of gases through the device primary hole.

5. The device according to claim 1 that moves other types of gases through the device primary holes.

6. The device according to claim 1 that moves liquid through the device primary hole.

7. The device according to claim 1 that moves liquid through the device primary holes.

8. The device according to claim 1 that cools the extruded plastic by starting cooling and stopping cooling for various lengths of time.

9. The device according to claim 1 that cools the extruded plastic continuously.

10. The device according to claim 1 that cools the extruded plastic with varying amounts of pressure.

11. The device according to claim 1 that starts cooling the extruded plastic immediately when the plastic extrusion stops.

12. The device according to claim 1 that starts cooling the extruded plastic before the plastic extrusion stops.

13. The device according to claim 1 that starts cooling the extruded plastic after the plastic extrusion stops.

14. The device according to claim 1 that contains a fan inside the device chamber that moves air through the primary hole.

15. The device according to claim 1 that contains a spherical object inside the device chamber that moves air through the primary hole when tipped.

16. The device according to claim 1 that contains a non-spherical object inside the device chamber that moves air through the primary hole when tipped.

17. The device according to claim 1 that contains a solenoid inside the device chamber that moves air through the primary hole when the solenoid is activated.

18. The device according to claim 1 that contains a solenoid inside the device chamber that moves air through the primary hole when the solenoid is deactivated.

19. The device according to claim 1 where the primary hole diameter is smaller than the device chamber diameter.

20. The device according to claim 1 where the primary hole diameter is larger than the device chamber diameter.

21. The device according to claim 1 where the primary hole diameter is the same size as the device chamber diameter.

22. The device according to claim 1 where the device chamber is sealed except for the device secondary hole and the device primary hole.

23. The device according to claim 1 where the device chamber is not sealed.

24. The device according to claim 1 that is attached to a 3D printer that extrudes the plastic.

25. The device according to claim 1 that is not attached to a 3D printer that extrudes the plastic.
